(19) United States
(12) Patent Application Publication
(10) Pub. No.: US 2009/0029195 A1
(43) Pub. Date: Jan. 29, 2009

(54) THIN FILM AND COMPOSITE ELEMENT PRODUCED FROM THE SAME

(75) Inventors: Ludwig J. Gauckler, Zurich (CH); Daniel Beckel, Zurich (CH); Ulrich Muecke, Zurich (CH); Patrik Muller, Rente (CH); Jennifer Rupp, Zurich (CH)

Correspondence Address: BACHMAN & LAPOINTE, P.C., 900 CHAPEL STREET, SUITE 1201, NEW HAVEN, CT, 06510, US

(73) Assignee: Eidgenossische Technische Hochschule Zurich, Zurich (CH)

(21) Appl. No.: 12/090,866

(22) PCT Filed: Oct. 16, 2006
(86) PCT No.: PCT/CH06/00573

§ 371 Date: Jul. 28, 2008

(30) Foreign Application Priority Data
Oct. 19, 2005 (CH) 1683/05

(51) Int. Cl. B32B 18/00; B32B 3/26; B32B 7/02; H01M 8/00

(52) U.S. Cl. 429/12; 428/325; 428/304.4; 428/213

(57) ABSTRACT

A thin film consisting of at least two layers of a ceramic material, a ceramic and metallic material, or in the case of several layers a metallic material. All layers of the thin film have a maximum average particle size of approximately 500 nm and at least two layers consist of different material. In at least one of said layers, an essentially stable average particle size remains after a relaxation time, even in an increased temperature range. The mechanical stability is preferably reinforced by a supporting, essentially flat substrate. In the composite element, the thickness of the substrate is at least five times and in particular between ten and a hundred times the thickness of the thin film. The composite element can be successfully used in a miniaturised electrochemical device, in particular in a solid oxide fuel cell SOFC, a sensor or as a gas separation membrane.

### TECHNICAL FIELD

The invention relates to a thin film that consists of at least two layers of a ceramic material, a ceramic and metallic material or, in the case of a number of layers, a metallic material and to a composite element with the substrate supporting it. Furthermore, the invention relates to uses of the composite element with the thin film.

### PRIOR ART

Thin films, in particular electrically conducting thin films of ceramic and/or metallic materials are currently gaining in importance the whole time. The thin films generally consist of a number of layers, in particular three to five, the material and/or the morphology of the individual layers generally being different. The thin film is generally deposited in layers on the substrate, customary thin-film techniques being used, for example chemical vapor deposition, pulsed laser vapor deposition, sol-gel methods, in particular rotational coating, or spray pyrolysis. Furthermore, the thin film may be applied to the substrate as a whole or layer by layer as such. After or during the application, the layers or the thin film as a whole is or are annealed in a single-stage or multi-stage process, to obtain a partially or fully crystalline microstructure. Multilayer thin films are also referred to as laminates.

U.S. Pat. No. 6,896,989 B2 describes thin films that are applied to a substrate, consist of a number of layers and can be used as electrodes and solid electrolyte in fuel cells. Arranged between these functional layers are further layers, also made of the material of the electrode. Optionally, additional layers of different materials may also be added. According to this patent specification, the individual layers of the thin film are deposited by methods that are known per se, such as RF (radio frequency) sputtering, PVD (physical vapor deposition), CVD (chemical vapor deposition) and electrophoresis.

### SUMMARY OF THE INVENTION

The present invention is based on the object of increasing the resistance to aging of thin films of the type mentioned at the beginning, in particular connected to a substrate, so that miniaturized electrochemical devices produced with the thin films do not suffer any losses in performance, or only minor losses, even over a long time.

The object is achieved according to the invention with respect to the thin films by the thin film having an average grain size of at most approximately 500 nm in all the layers, at least two layers consisting of different material, and an essentially stable average grain size being retained in at least one of these layers after a relaxation time, even in an elevated temperature range. Special embodiments and further developments of the invention are the subject of dependent patent claims.

A major advantage of these thin films is that the grains of at least one layer exhibit only limited growth over time; they no longer grow once they reach an average grain size dependent on the material and the production method. The relaxation time generally lies between 5 and 20 hours, in particular around 10 hours. An essentially stable average grain size can be maintained at temperatures up to preferably approximately 1100° C. This advantageous property results from an usually high proportion of amorphous material in the thin film before the annealing process, which greatly inhibits the grain growth by the buildup of microscopic stresses between the amorphous matrix and the relatively small grains. If the average grain size does not lie in the range according to the invention, most materials exhibit unlimited grain growth for very long times at constant and elevated temperature, and consequently increased aging/degradation.

An approximately stable average grain size is understood in the present case as meaning that the deviation after the relaxation time is at most approximately □10%, preferably at most approximately □5%. In the case of an average grain size of, for example, 500 nm, the subsequent grain growth expediently lies in the range of at most approximately 25 nm, in particular at most approximately 10 nm.

The individual layers of the thin film have in practice a thickness of from 5 to 10,000 nm, preferably from 10 to 1000 nm, with an average grain size K of at most approximately 200 nm, preferably from 5 to 100 nm. With respect to the layer thickness of an individual layer of the thin film, the average grain size K is preferably at most approximately 50%, in particular at most approximately 20%. Here and hereafter, an amorphous or partially amorphous layer structure is not specifically mentioned but is analogously attributed to the fine-grained thin films.

According to a particularly advantageous embodiment of the invention, the thin film always has at least two layers that are ionically or ionically and electronically conducting, in particular for O²⁻ ions. At least one of these layers is always predominantly ionically conducting, and at most slightly electronically conducting.

The electrical conductivity is generally in the range from 0.02 to 10⁵ S/m (Siemens/meter). Electrical conductivity may be required on an application-related basis, for example in the case of electronically active electrodes and electrolytes that are used as miniaturized sensors or fuel cells.

The thin films may comprise various layers of a laminar structure that are in themselves homogeneous, with a chemical composition, morphology and/or porosity that is slightly changed continuously from layer to layer, a gradient being established with respect to the chemical composition, morphology and/or porosity. If, for example, one or more layers of the thin film is or are porous, the porosity is in a range from >0 to 70% by volume. The porosity may vary from layer to layer, with a continuous increase or decrease to form a porosity gradient.

The thin film that is used most frequently in practice comprises an anode layer, a solid electrolyte layer and a cathode layer, all the layers being electrically conducting. Depending on requirements, these layers may comprise further layers lying in between or formed as outer layers.

The layers of the thin film consist of at least one ceramic or at least one metal, but also of a mixture of at least one ceramic and at least one metal; the latter composition is also known as cermet. A thin film may not be purely metallic; at least one layer must be predominantly ionically conducting. The individual layers (including the ceramic-containing layers) of the thin film may be amorphous, two-phase amorphous-crystalline or completely crystalline.

Sufficient mechanical stability is imparted to the thin film according to a further embodiment of the invention by the thickness of a substrate supporting it corresponding to at least approximately five times, preferably at least approximately ten times, the layer thickness of the thin film. The layer thickness of the substrate may also reach one hundred times the layer thickness of the substrate or more. The substrate, consisting of any desired, suitable material, may be formed such that it is flexible, for example as a sheet, or rigid, for example as a plate. Both embodiments of the substrate can be impermeable, porous over the entire surface area or parts thereof and/or have holes or channels that can be configured as desired, which is referred to as a structured substrate. At least parts of the porous regions and the holes or channels are covered by the thin film, which in this function is referred to as a membrane. The channels also serve for fluid distribution; they may also be formed as grooves that pass only part of the way through the substrate.

The holes or channels passing through the substrate are expediently each at least 100 μm² in size and of any desired, but expedient, geometrical form. The surface area of these holes or channels is set an upper limit by the mechanical stability of the thin film acting as a membrane.

The individual layers of the thin film covering the openings in the substrate do not have to be of the same size with respect to surface area. At least one layer of the thin film must cover at least one of the substrate openings. Each of the other layers of the thin film may cover this first layer entirely or partially or extend beyond the first layer. The layers of the thin film acting as a membrane may be structured by selective depositing or etching, by lift-off or masking techniques, or by any desired combination of these forms of deposition or in any desired form.

For miniaturized devices with electrochemically active electrodes and a solid electrolyte, a thin film with at least three of these fine-grained layers one on top of the other may be applied to a substrate as a membrane. As mentioned at the beginning, the working techniques are known per se.

According to a material-related variant of the invention, one or more layers of the thin film consists or consist of a metal or a metal oxide, for example of Cu, Co, Mn, Ag, Ru or NiOₓ, FeOₓ, MnOₓ, CuOₓ, CoOₓ, MnOₓ, AgOₓ, RuOₓ or mixtures of metals and/or metal oxides. Furthermore, a ceramic component with ionic or mixed ionic and electronic conductivity, such as for example doped ceroxide AₓCe₁₋ₓO_{2-δ}, where A=Gd, Sm, Y, Ca, 0.05≦x≦0.3, or doped zirconium oxide Ln_{y}Zr_{1-y}O_{2-δ}, where Ln=Y, Sc, Yb, Er, 0.08≦y≦0.12, may be added to the metal, metal oxide or the mixture of metal and metal oxide. The proportion by volume of the metal and ceramic component lies between 20 and 80% by volume. The proportion by volume of the metallic phase of the solid part of the cermet lies between >0 and 70% by volume. The ratio between metal and ceramic may be both uniformly distributed and singly or multiply graduated over the film thickness, with a ratio between 0 (no metal in the layer) and 100% (pure metal layer) of metal at each location of the thin film. The porosity of the thin film ranges from 0 to 50% in the oxidized state; all the metallic components are in the form of metal oxide, and 0 to 70% for the reduced state; all the metallic components are in the form of metal, with a homogeneous or a non-homogeneous distribution in the thin film. The porosity may take the form of a gradient from impermeable to 70% porosity of the thin film. The average grain size K of the materials can be determined by thermal annealing at different temperatures; it comprises average grain sizes K of from 5 to 500 nm. The ceramic phase of the layers of the thin film has stable microstructures as a function of time under reducing conditions at temperatures of up to 700° C. If the metal content lies above a certain limit volume from which the metallic conduction becomes perceptible, the overall electrical conductivity between room temperature and 700° C. is greater than 10 S/m; the metal is in a reduced, that is to say metallic, state. All these materials can be coated, impregnated or doped with the following metals, or form composite materials with these metals, for example Ag, Au, Cu, Pd, Pt, Rh and Ru.

According to a second material-related variant of the invention, one or more of the layers of the thin film consists or consist of doped ceroxide AₓCe₁₋ₓO_{2-δ}, where A=Gd, Sm, Y, Ca, 0.05≦x≦0.3, or of doped zirconium oxide Ln_{y}Zr_{1-y}O_{2-δ}, where Ln=Y. Sc, Yb, Er, 0.08≦y≦0.12, or of La₁₋ₓSrₓGa_{1-y}Mg_{y}O_{3±δ}, with 0≦x≦1 and 0≦y≦1. The layers of this thin film are of an impermeable nanostructure and have a film thickness of between 10 and 5000 nm. A thin film with layers of an average grain size K of between 5 and 500 nm can be produced. This thin film has the following electrical properties:

a) An overall electrical conductivity of between 0.02 and 5 S/m at 500° C. and 0.25 and 10 S/m at 700° C., both measured in air.

b) An activation energy of the electrical conductivity in air of between 0.5 and 1.5 eV within the temperature range of 100 to 1000° C.

c) The electrolytic domain boundary is at 500° C. under oxygen partial pressures lower than 10⁻¹⁹ atm and at 700° C. under oxygen partial pressures lower than 10⁻¹⁴ atm.

According to a third material-related variant of the invention, one or more layers of the thin film consists or consist of a perovskite of the type AₓA′₁₋ₓB_{y}B′_{1-y}O_{3±δ}, where A, A′, B and B′ are one of the following elements: Al, Ba, Ca, Ce, Co, Cu, Dy, Fe, Gd, La, Mn, Nd, Pr, Sm, Sr, Y and 0≦x≦1, 0≦y≦1. According to a subvariant, pyrochlore ruthenates of the composition A₂Ru₂O_{7±δ}, where A=Bi, Y, Pb or A_{2-α}A′_{α}MO_{4±δ} with (A=Pr, Sm; A′=Sr; M=Mn, Ni; 0≦α≦1) or a material of the following composition: A₂NiO_{4±δ} (A=Nd, La); AₓB_{y}NiO_{4±δ} with A, B═Al, Ba, Ca, Ce, Co, Cu, Dy, Fe, Gd, La, Mn, Nd, Pr, Sm, Sr, Y and 0≦x≦1, 0≦y≦1, or La₄Ni₃₋ₓCoₓO_{10±δ}, or YBa(Co,Fe)₄O_{7±δ} or Baln₁₋ₓCoₓO_{3±δ} or Bi₂₋ₓYₓO₃ (0≦x≦1) or La₂Ni₁₋ₓCuₓO_{4±δ} (0≦x≦1), or Y₁Ba₂Cu₃O₇ is used. All these materials can be coated, impregnated or doped with the following metals or form composite materials with these metals: Ag, Au, Cu, Pd, Pt, Rh and Ru. Furthermore, the thin films may comprise a mixture of these materials with doped ceroxide AₓCe₁₋ₓO_{2-δ}, where A=Gd, Sm, Y, Ca, 0.05≦x≦0.3, or doped zirconium oxide Ln_{y}Zr_{1-y}O_{2-δ}, where Ln=Y, Sc, Yb, Er, 0.08≦y≦0.12, or La₁₋ₓSrₓGa_{1-y}Mg_{y}O_{3±δ}, where 0≦x≦1 and 0≦y≦1. The thin films preferably have a layer thickness of between 50 and 10,000 nm and an average grain size K of between 5 and 500 nm. The overall electrical conductivity at 550° C. is in the range between 10 and 100,000 S/m in air. The thin films are stable in air and may be impermeable or porous with a porosity of between >0 and 70% by volume.

Finally, in addition to at least one ceramic or cermet layer, one or more layers of the thin film may be in the form of a metal or a metal mixture, for example Pt, Au, Ag, Ni and others, which are produced by sputtering techniques, such as RF (radio frequency) or direct-current sputtering, a vapor depositing technique or any other vacuum technique, electrochemical deposition or a paste of metal oxide powder and any organic or non-organic component.

Further advantageous embodiments and combinations of features of the invention emerge from the following detailed description and the patent claims in their entirety.

### BRIEF DESCRIPTION OF THE DRAWINGS

The invention is explained in more detail on the basis of exemplary embodiments that are represented in the drawing and are the subject of dependent patent claims. In the schematic cross sections:

FIG. 1 shows a thin film with three layers

FIG. 2 shows a composite element with a thin film according to FIG. 1

FIG. 3 shows a thin film comprising two layers as a gas-separating membrane

FIG. 4 shows a porous substrate with a thin film

FIG. 5 shows an impermeable substrate with a continuous hole or channel with a thin film

FIG. 6 shows an impermeable membrane with various forms of hole (plan view)

FIG. 7 shows a miniaturized fuel cell with a composite element

FIG. 8 shows a variant of FIG. 7

FIG. 9 shows a further fuel cell (view from below)

FIG. 10 shows a single-chamber fuel cell with electrodes of a thin-film membrane next to one another

FIG. 11 shows a single-chamber fuel cell with a porous solid electrolyte of the thin-film membrane

FIG. 12 shows a fuel cell according to FIG. 7 with a protective layer on the substrate

FIG. 13 shows a fuel cell according to FIG. 7 with a heating element

FIG. 14 shows a thin film with a gradient

FIG. 15 shows a gas sensor with a thin-film membrane, and

FIG. 16 shows a diagram with the average grain size growth.

In principle, the same parts are provided with the same designations in the figures.

### WAYS OF CARRYING OUT THE INVENTION

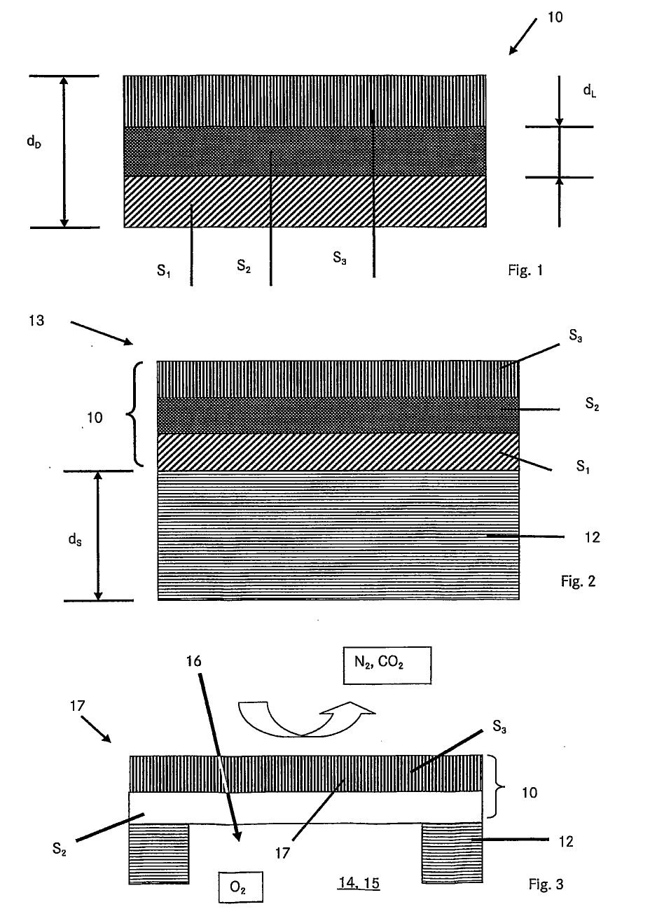

FIG. 1 shows a thin film 10 with a laminate structure comprising three layers, a first layer S₁, a second layer S₂ and a third layer S₃. In the present case, the first layer S₁ is a cermet layer with a proportion of metal of 40% and a proportion of ceramic of 60%; it has the specification Ni—Ce_{0.8}Gd_{0.2}O_{1.9}. The second layer S₂, conducting for reduced oxygen ions O²⁻, has the specification Ce_{0.8}Gd_{0.2}O_{1.9}. The third layer S₃ has in the present case the specification La_{0.6}Sr_{0.4}CO_{0.2}Fe_{0.8}O₃. The thickness of a layer S₁, S₂, S₃ is denoted by d_{L}.

FIG. 2 shows a thin film 10 according to FIG. 1, which comprises a film composite in laminate form, which has been applied to a substrate 12 and forms a composite element 13 which serves as a functional element. This substrate 12 imparts the necessary mechanical strength to the thin film 10. According to a preferred variant, the layers S₁, S₂ and S₃ are deposited in series by a method that is known per se, it also being possible for the area extent of the individual layers to differ. A thin film 10 applied to a substrate 12 is also referred to as a membrane or a thin-film membrane. For reasons of clarity, the thickness of the substrate d_{S} is shown here and elsewhere as smaller than it should be; it is a multiple of the layer thickness d_{D} of the thin film 10.

Represented in FIG. 3 is a gas-separating membrane 10, which merely comprises two different, selectively gas-permeable solid electrolyte layers S₂ and S₃. A hole 14 or channel 15 passing completely through the substrate 12 exposes the underside of the thin-film membrane 10 and forms a window. The gas inflow 16, indicated by a straight arrow, is divided at the thin-film membrane 10. The oxygen can pass through the ion-conducting layers S₂ and S₃ and is separated from the deflected main flow of predominantly nitrogen N₂ and carbon dioxide CO₂. The thin film 10 comprising the layers S₂ and S₃ is therefore also referred to as gas-separating membrane 17.

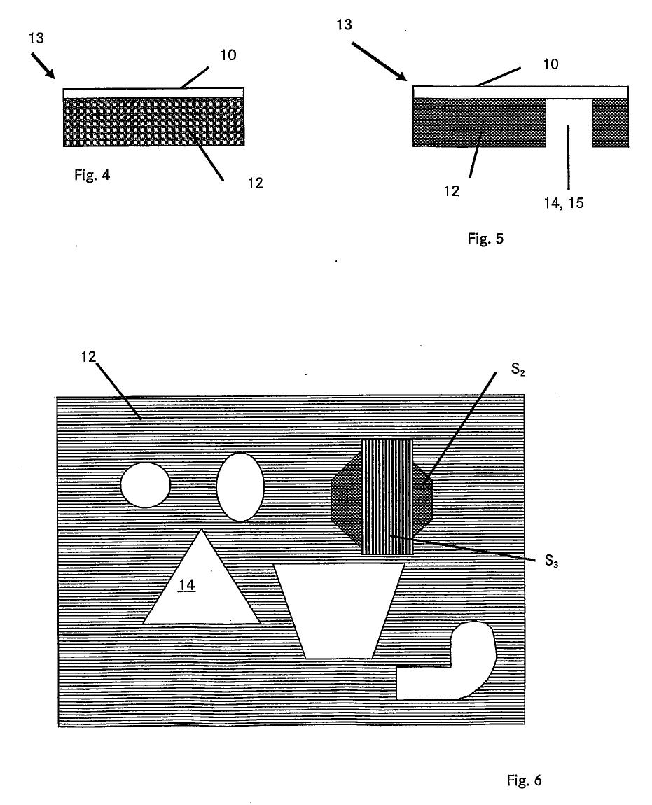

FIGS. 4 to 6 show special embodiments of substrates 12 of a flat form. FIG. 4 shows a porous substrate 12. A fraction of the gas inflow passing through a thin-film membrane 10 can flow away through the porous substrate 12, without holes 14 or channels 15 having to be provided.

A fraction of a gas inflow impinging on a gas-impermeable substrate 12 according to FIG. 5 after passing through the thin film must be able to flow away, as represented in FIG. 3, for which reason at least one hole 14 passing through the substrate 12, or a corresponding channel 15, must be provided.

FIG. 6 shows a selection of possible embodiments of holes 14 passing through the substrate 12, which are shaped in a circular, oval, polygonal or any desired manner. These holes 14 are always covered by a thin film 10 that is not shown. In the case of a multilayer thin-film membrane, the holes must be covered by at least one layer; the other layers may also cover the hole only partially, as indicated in the case of the octagonal hole 14. The layer S₂, a solid electrolyte, covers the octagonal hole 14 completely; the layer S₃, for example a cathodic layer, covers it only partially.

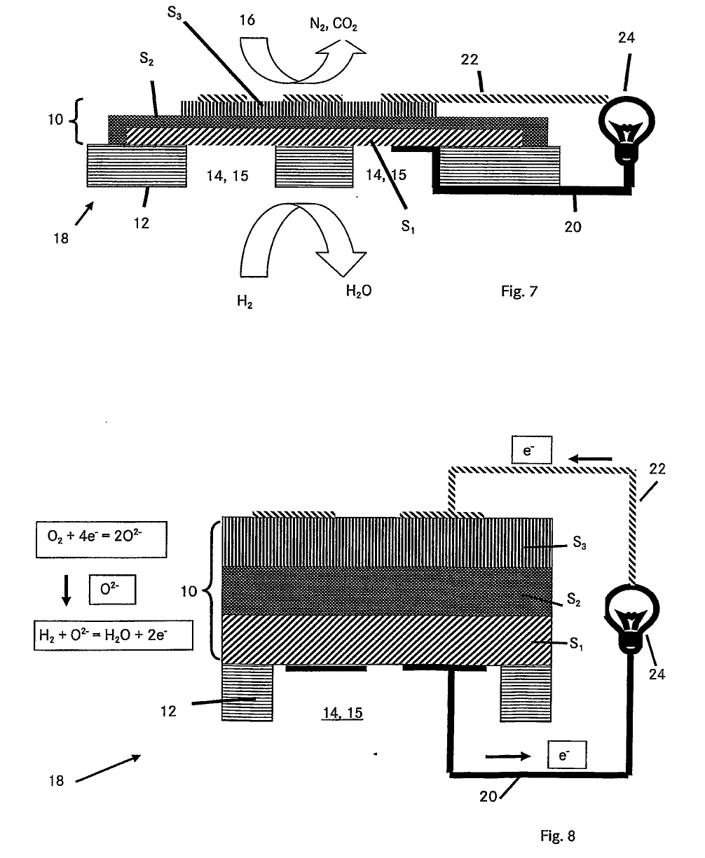

FIGS. 7 and 8 show an important area of use of the thin film 10 or composite element 13 according to the invention, a miniaturized fuel cell 18 (solid oxide fuel cell, SOFC), the main functional elements of which in two variants of its embodiment are represented. FIG. 7 additionally shows the gas flows, to be specific the gas inflow 16, flowing around the cathodic third layer S₃, and the gas flow containing H₂ and/or hydrocarbons, flowing around the anodic first layer S₁. The atmosphere is oxidizing or reducing, according to the electrode. FIG. 8 also shows the electrochemical reaction sequence.

The thin-film membrane 10 with the electrochemically active layers of the miniaturized fuel cell 18 essentially comprises

an anodic first layer S₁ of a cermet, resting on a rigid substrate plate 12 with holes 14 or channels 15,

a second layer S₂, also laterally covering the anode and formed as a solid electrolyte, and

a cathodic third layer S₃, resting on the solid electrolyte.

The anodic layer S₁ and the cathodic layer S₃ are each connected to a metallic current conductor 20, 22 and lead the direct electric current that is generated via a load 24. The electrodes S₁, S₃ may contain catalytically active metal particles.

The electrode layers S₁ and S₃ are formed such that they are gas-permeable; the electrode layer S₂ is gas-impermeable, but permeable to oxygen ions, which is indicated in FIG. 8. When there is an inflow of gas 16, in the present case air, the nitrogen N₂ and the carbon dioxide CO₂ are deflected—as already represented in FIG. 3—, the oxygen ions O²⁻ pass through the solid electrolyte layer S₂ to the anodic first layer S₁ and react at the interface while oxidizing with the hydrogen supplied as fuel to form water. This is carried away as exhaust gas.

As shown in FIG. 8, the electrons e⁻ released during the oxidation of the oxygen ions O²⁻ are led via a load 24 to the cathodic layer S₃, where the reaction is started up again and oxygen is reduced.

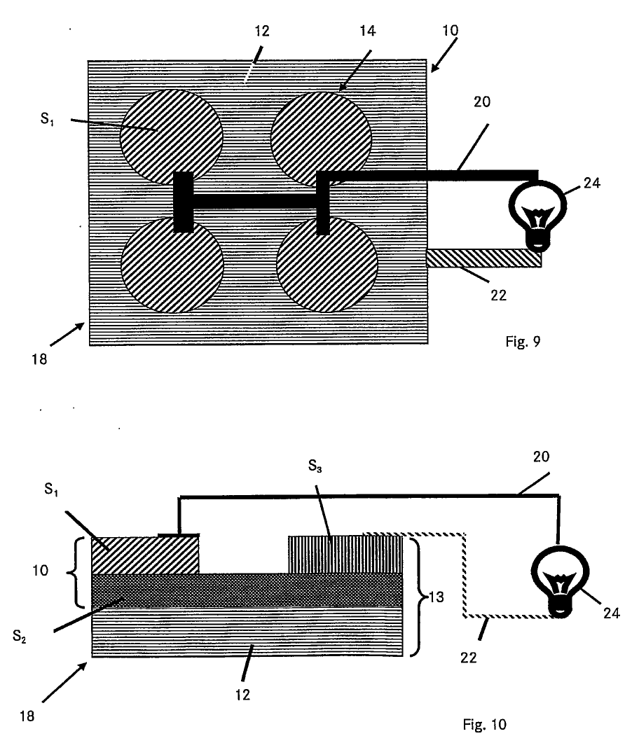

FIG. 9 is a basic diagram of the functional part of a fuel cell SOFC 18, represented from below. The anodic first layer S₁ of a thin-film membrane 10 applied to the substrate 12 can be seen through four holes 14 in a substrate 12. A metallic anodic current conductor 20 is connected to this layer S₁ and is connected in an electrically conducting manner via a load 24 and a metallic cathodic current conductor 22 to the cathodic layer of the thin-film membrane, which cannot be seen.

Represented in FIG. 10 is the functional principle of a miniaturized single-chamber fuel cell 18, in which the anodic first layer S₁ and the cathodic third layer S₃ are arranged on the same side of the second layer S₂, a solid electrolyte. The thin film 10 is in turn applied to a substrate 12 to form a composite element, and forms a composite element 13. The electric current that is generated by the miniaturized fuel cell SOFC 18 during operation is passed via the metallic current conductors 20, 22 to a load 44.

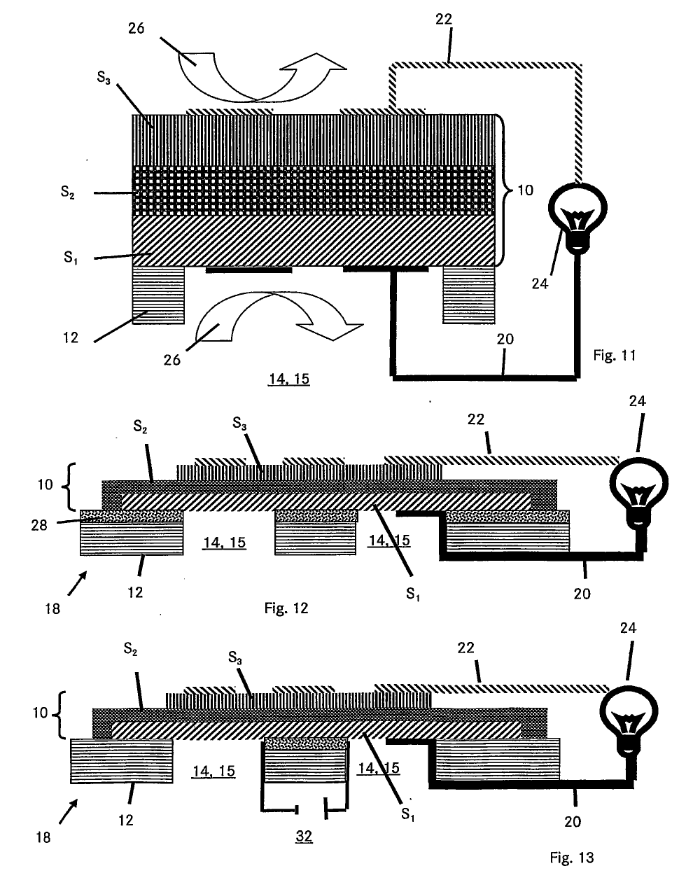

FIG. 11 shows a further miniaturized fuel cell SOFC 18 with a second layer S₂, formed as a porous solid electrolyte. Together with the anodic first layer S₁ and the cathodic layer S₃, this layer forms the thin-film membrane 10, which is supported by a substrate 12 with a hole 14 or channel 15. As usual in a single-chamber SOFC, both the anodic layer S₁ and the cathodic layer S₃ are surrounded by the flow of a mixture of air, fuel and exhaust gas, which is indicated by arrows 26. A hydrocarbon that is introduced along with or in place of H₂ may be liquid or gaseous.

A miniaturized SOFC 18 that is represented in FIG. 12 corresponds essentially to that of FIG. 7. The only significant difference is that a protective layer 28 is arranged between the anodic layer S₁ and the part of the layer S₂ formed as a solid electrolyte that encloses this anode, on the one hand, and the substrate 12, on the other hand. This protective layer consists in the present case of silicon nitride Si₃N₄.

A further variant according to FIG. 7 is represented in FIG. 13. A heating element 30, which is fed by a direct current source 32, is arranged between the central web 34 of the substrate 12, which separates the two channels 15 for fluid distribution, and the anodic first layer S₁. The heating element 30 may extend over further regions.

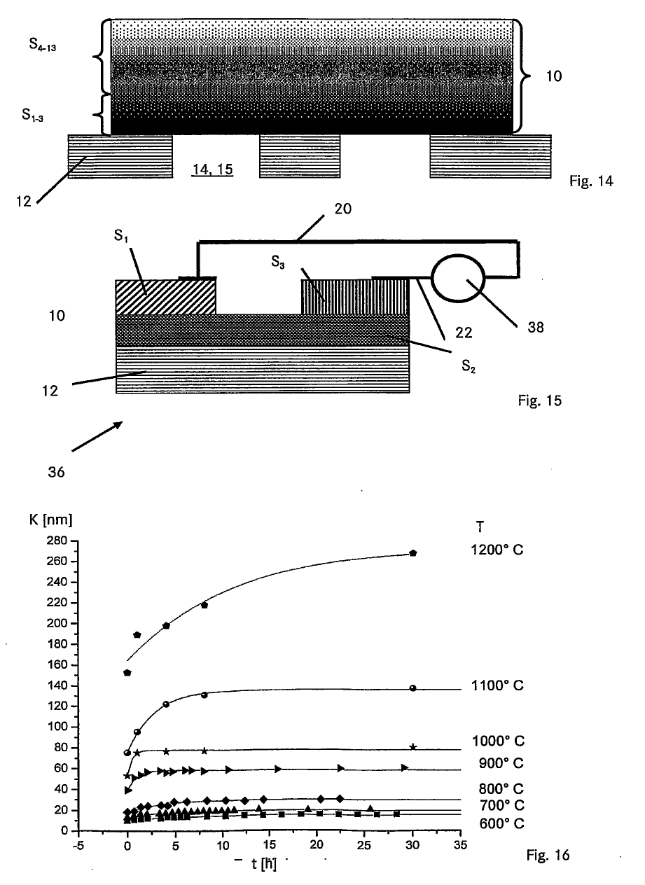

In FIG. 14, a thin film 10 is formed with a total of 13 layers, not only the layers referred to in the previous figures, S₁, S₂ and S₃, but also the layers S₄ to S₁₃. The porosity is constant within the individual layers S₁ to S₁₃, but the individual layers exhibit a porosity that decreases in stages. As a result, a gradient is formed. Parameters other than the porosity may also form a gradient, for example the chemical composition and/or the morphology.

FIG. 15 shows the structural principle of a sensor 36 with a thin film 10 on a substrate 12. The second layer S₂, forming the solid electrolyte, is connected over its full surface area to the impermeable substrate 12. On the other side of the second layer S₂, two electrodes are arranged separately from each other, a high-grade metal electrode forming the first layer S₁, in the present case of platinum, and a metal oxide electrode forming the third layer S₃, in the present case of La_{0.6}Sr_{0.4}CrO₃.

The solid electrolyte that is permeable to oxygen ions, layer S₂, consists in the present case of ZrO₂ doped with 8% Y₂O₃. The resistance measured over current conductors 20, 22 is fed to a measuring instrument 38 with a display area.

The diagram according to FIG. 16 shows the mean average grain size K of electrolyte layers in nanometers (nm), which is plotted against time t in hours (h) for different temperatures (T). The values are based on measurements of electrolyte layers of Ce_{0.8}Gd_{0.2}O_{1.9} which were produced by means of spray pyrolysis and had layer thicknesses in the submicron range. After deposition, such layers are in an impermeable, but partially amorphous state and are completely free from cracks. In a further process step, the layers are heated up at a rate of 3° C./min to the temperatures (T) indicated in FIG. 16 of between 600 and 1200° C. and are isothermally annealed for 35 h at the corresponding temperature. Electrolyte layers of Ce_{0.8}Gd_{0.2}O_{1.9} that are annealed for example at 600° C. have at the time t=0 h an average grain size of 10±3 nm and a proportion in the amorphous phase of 31±9% by volume. Within the first 12±3 h, the grains grow to a stable grain size of 16±3 nm; after that, no further grain growth can be observed as annealing progresses.

The diagram (FIG. 16) also reveals that, after approximately 12 hours at the latest, no measurable grain size growth occurs any longer at temperatures up to 1100° C. At a temperature of 1200° C., on the other hand, the curve continues to rise even after 15 hours. The oxide ceramic investigated here for the solid electrolyte layer is therefore no longer usable above a temperature of 1100° C. because of the grain growth.

1. A thin film that consists of at least two layers of a ceramic material, a ceramic and metallic material or, in the case of a number of layers, a metallic material,
wherein
the thin film has an average grain size of at most approximately 500 nm in all the layers, at least two layers consisting of different material, and an essentially stable average grain size being retained in at least one of these layers after a relaxation time, even in an elevated temperature range.

2. The thin film as claimed in claim 1, wherein the individual layers have a thickness of from 5 to 10,000 nm, preferably from 10 to 1000 nm, an average grain size of at most approximately 200 nm, preferably 5 to 100 nm, the average grain size preferably being at most approximately 50%, in particular up to at most approximately 20% of the layer thickness concerned.

3. The thin film as claimed in claim 1, wherein, after a relaxation time of from 5 to 20 h, preferably approximately 10 h, and a temperature of up to 1100° C., it has an essentially stable average grain size.

4. The thin film as claimed in one of claims 1, wherein the average grain sizes are stable after the relaxation time, with a maximum deviation of approximately ±10%, preferably of approximately ±5%.

5. The thin film as claimed in claim 1, wherein at least one layer is ionically or ionically and electronically conducting, in particular for O²⁻ ions.

6. The thin film as claimed in one of claims 1, wherein electrically conducting layers have a material- and temperature-dependent conductivity of from 0.02 to 10⁵ S/m.

7. The thin film as claimed in claim 1, wherein the chemical composition, the morphology and/or the porosity of neighboring layers, which are homogeneous within an individual layer, increase or decrease continuously to form a corresponding gradient.

8. The thin film as claimed in claim 1, wherein at least one layer has a porosity of >0 to 70% by volume.

9. The thin film as claimed in claim 1, wherein it comprises an anodic layer, a solid electrolyte layer and a cathodic layer, all the layers preferably being electrically conducting.

10. The thin film as claimed in claim 1, wherein at least one layer consists of at least one ceramic or of at least one ceramic and at least one metal.

11. A composite element with a thin film as claimed in claim 1, wherein it comprises a substrate supporting the thin film and of an essentially flat form, the thickness of the substrate supporting it and connected to it corresponding to at least approximately five times, preferably approximately ten to one hundred times, the total layer thickness (d_{D}) of the thin film (10).

12. The composite element as claimed in claim 11, wherein the thin-film membrane stretches over porous zones and/or at least one continuous hole or a continuous channel of the substrate.

13. The composite element as claimed in claim 12, wherein the holes or channels in the supporting substrate are at least 100 μm² in size and of any desired geometrical form.

14. The composite element as claimed claim 11, wherein the supporting substrate is formed as a flexible sheet or as a rigid plate.

15. The composite element as claimed in claim 11, wherein a protective layer, preferably of silicon nitride, is arranged between the thin film and the substrate.

16. The composite element as claimed in claim 11, wherein a heating element is arranged at least on part of the composite region between the thin film and the substrate.

17. The use of a composite element as claimed in claim 11, wherein with the thin film as claimed in claim 1 in a miniaturized electrochemical device, in particular a solid fuel cell SOFC, a sensor or as a gas-separating membrane.
